(19) United States
(12) Patent Application Publication
(10) Pub. No.: US 2014/0270314 A1
(43) Pub. Date: Sep. 18, 2014

(54) Earphones in a Magnetic Resonance Imaging System

(71) Applicants: Xiao Guang Liu, Shenzhen (CN); Xu Yan, Shenzhen (CN)

(72) Inventors: Xiao Guang Liu, Shenzhen (CN); Xu Yan, Shenzhen (CN)

(21) Appl. No.: 14/202,050

(22) Filed: Mar. 10, 2014

(30) Foreign Application Priority Data
Mar. 15, 2013 (CN) 201320118013.X

(51) Int. Cl. H04R 1/10

(52) U.S. Cl. CPC H04R 1/105
USPC 381/380

(57) ABSTRACT

Disclosed is an earphone including: an earplug that is a rigid pipe; a soft cap that is an elastic sheath, wherein the soft cap includes a body and a top end, the body being in the form of a hole, the top end covering one end of the body, an inner wall of the body matching an outer wall of the earplug, and one end of the earplug being positioned in the body. The earphone not only may reduce noise but also enables useful information to be heard, as well as ensuring that foreign matter cannot enter the earphone and the soft cap may be detachably fixed to the earplug so as to guarantee sanitary use.

### CROSS-REFERENCE TO RELATED APPLICATIONS

This application claims the benefit of CN 201320118013.X, filed on Mar. 15, 2013, which is hereby incorporated by reference in its entirety.

### TECHNICAL FIELD

The present embodiments relate to the technical field of medical equipment, and, in particular, an earphone used in a magnetic resonance imaging system.

### BACKGROUND

Magnetic resonance imaging (MRI) is a technology in which the phenomenon of magnetic resonance is utilized for the purpose of imaging. The main principles of magnetic resonance are as follows. Where an atomic nucleus contains a single proton, as is the case for example with the nuclei of the hydrogen atoms that are present throughout the human body, this proton exhibits spin motion and resembles a small magnet. Moreover, the spin axes of these small magnets lack a definite pattern, and if an external magnetic field is applied, the small magnets will be rearranged according to the magnetic force lines of the external field. Specifically, the magnets will line up in two directions, either parallel or anti-parallel to the magnetic force lines of the external magnetic field. The direction parallel to the magnetic force lines of the external magnetic field is called the positive longitudinal axis, while the direction anti-parallel to the magnetic force lines of the external magnetic field is called the negative longitudinal axis. The atomic nuclei only have a longitudinal magnetization component that has both a direction and a magnitude. A radio frequency (RF) pulse of a specific frequency is used to excite the atomic nuclei in the external magnetic field such that their spin axes deviate from the positive longitudinal axis or negative longitudinal axis, giving rise to resonance. This is the phenomenon of magnetic resonance. Once the spin axes of the excited atomic nuclei have deviated from the positive or negative longitudinal axis, the atomic nuclei have a transverse magnetization component. Once emission of the RF pulse has ended, the excited atomic nucleus emits an echo signal, gradually releasing the absorbed energy in the form of electromagnetic waves, such that the atomic nucleus' phase and energy level both return to the pre-excitation state. An image may be reconstructed by subjecting the echo signal emitted by atomic nuclei to further processing, such as spatial encoding.

Compared with other medical equipment, there is no doubt that MRI systems have provided a safer and more reliable means of diagnostic imaging. However, owing to the way in which the equipment of an MRI system itself works, patients still feel effects from MRI systems during use, an example of which is noise during scanning.

The most direct solution to noise is earplugs. However, during operation of an MRI system, the doctor or operator still has to communicate with the patient or examination subject, in order to guide the latter in adjusting posture or to enquire about his/her condition. Such communication is of vital importance to proper imaging of the patient or examination subject, and even to his/her safety, so the patient or examination subject must be able to hear information from the doctor or operator clearly. Thus, the question of how to transmit voice information while avoiding noise has become a technical problem of MRI systems.

The US patent publication document WO 2005/044140 A2 has proposed an earphone for an MRI system, where a channel used to transmit sound waves is enclosed in a soundproofing structure made of an elastic material. Once the earphone has been inserted in the ear canal, the soundproofing structure may block noise, but foreign matter easily enters the earphone through that end of the channel used to transmit sound waves that is in communication with the ear canal. This will cause the earphone to develop a fault, or even become blocked. Furthermore, the soundproofing structure is not connected to the channel in a fixed way, so that an external force in contact with the ear canal will cause dislocation and thereby make it difficult to block noise.

### SUMMARY AND DESCRIPTION

The scope of the present invention is defined solely by the appended claims and is not affected to any degree by the statements within this summary. The present embodiments may obviate one or more of the drawbacks or limitations in the related art.

In response to the above technical problem, the object of the embodiments is to provide an earphone including: an earplug that is a rigid pipe; a soft cap that is an elastic sheath, wherein the soft cap includes a body and a top end, the body being in the form of a hole, the top end covering one end of the body, an inner wall of the body matching an outer wall of the earplug, and one end of the earplug being positioned in the body.

In certain embodiments, the outer diameter of the soft cap decreases gradually from the body side to the top end side. The sound damping provided by the material of the body may be greater than the sound damping provided by the material of the top end. The top end may include one or more through-holes that run through an inner wall and outer wall of the top end. The earplug may include one or more flanges located on the outer wall of the earplug.

In certain embodiments, the side cross section of the flange may be rectangular. The side cross section of the flange may be in the shape of a triangle. In some embodiments, the triangle is a right triangle, one of the acute angles of the right triangle pointing towards the top end, and the other acute angle of the right triangle pointing towards an outer wall of the body.

One embodiment is characterized in that one or more grooves are provided on the inner wall of the body, the groove matching the flange. In one embodiment, the earplug is detachably connected to the soft cap.

In response to the above technical problem, another object of the embodiments is to provide a sound-making device, including any one of the earphones described above and a sound/pressure converter.

In response to the above technical problem, another object of the embodiments is to provide an MRI system including the sound-making device described above.

It may be seen that compared with earphones in the prior art, the earphone according to the embodiments offers a stronger noise reduction effect. The earphone according to the embodiments is of much smaller volume than headphones, and does not need to be secured with the aid of the head; thus the patient is more comfortable, especially when using a head coil at the same time. The earphone according to a particular embodiment may avoid faults or blockage caused by foreign matter entering the earplug, as well as avoiding an inability to block noise as a result of dislocation of the soft cap.

### BRIEF DESCRIPTION OF THE DRAWINGS

FIG. 1 depicts a schematic diagram of a particular embodiment of an earplug.

### DETAILED DESCRIPTION

Embodiments are explained in greater detail below by way of examples, in order to clarify the object, technical solution and advantages thereof.

To solve the problems mentioned in the background art section, as described above, in order to be able not only to reduce noise but also to hear useful information, as well as to ensure that foreign matter cannot enter the earphone and the soundproofing structure may be fixed to the channel, the following particular embodiments are presented.

The embodiments propose an earphone, including: an earplug that is a rigid pipe; a soft cap that is an elastic sheath, wherein the soft cap includes a body and a top end, the body being in the form of a hole, the top end covering one end of the body, an inner wall of the body matching an outer wall of the earplug, and one end of the earplug being positioned in the body.

FIG. 1 depicts a schematic sectional drawing of an earphone according to a particular embodiment. Specifically, the embodiments propose an earphone that mainly includes an earplug 100 and soft cap 200.

As FIG. 1 depicts, the earplug 100 is a molded rigid pipe. The soft cap 200 is a molded elastic sheath. The soft cap 200 has a body 201 and a top end 202, the body 201 being in the form of a hole (e.g., a cylindrical hole), and one end of the body 201 being covered by the top end 202. An inner wall of the body 201 matches an outer wall of the earplug 100, enabling one end of the earplug 100 to be inserted in the hole of the body 201.

The outer diameter of the soft cap decreases gradually from the body side to the top end side. As FIG. 1 depicts, the side cross section of the earphone according to a particular embodiment is essentially tapered. Such a shape is better able to adapt to the structure of the ear canal, facilitating use by a patient while reducing feelings of discomfort.

The soft cap 200 is made of foamed plastic, wherein the material of the body 201 provides a higher level of sound damping, while the material of the top end 202 provides a lower level of sound damping. Such a soft cap structure, in which a body and a top end providing different levels of sound damping work in cooperation, may not only allow sound waves to enter the ear canal, but also prevent secretions inside the ear canal from entering the earplug, thereby serving the function of maintaining cleanliness during use.

Furthermore, the top end 202 further includes one or more minute through-holes that run through an inner wall and outer wall of the top end 202 so as to transmit sound from the earplug to the ear canal better.

Furthermore, the earplug 100 includes one or more flanges 101 and 102; a groove matching the flange 101 is provided on the inner wall of the body 201 of the soft cap 200, so that the soft cap 200 is fixed on the earplug 100 through the cooperation of the groove with the flange 101. As FIG. 1 depicts, the side cross section of the flange 101 is in the shape of a right triangle. One of the acute angles of the right triangle points towards the top end 202 of the soft cap 200, while the other acute angle of the right triangle points towards an outer wall of the body 201 of the soft cap 200. The fact that the earplug 100 is designed so that the soft cap 200 is fixed on the earplug 100 allows that the position of the earplug 100 in the soft cap 200 will be neither too shallow nor too deep.

Furthermore, the earphone further includes a soft tube 300, one end of the soft tube 300 being connected to the earplug 100, and one end being connected to a sound/pressure converter. The side cross section of the flange 102 is rectangular, the flange 102 preventing the position of the earplug 100 in the soft tube 300 from being too deep. In certain embodiments, the earphone may further include a hard tube 400 connected between the soft tube 300 and the sound/pressure converter 500.

To use the earphone according to a particular embodiment, the soft cap 200 is pinched to the soft cap's minimum size and thereby inserted in the ear together with the earplug 100. After a few seconds, the soft cap 200 will gradually recover the soft cap's original state and thereby fill the ear canal of the patient, achieving the aim of preventing noise from entering. At the same time, since the earplug 100 extends into the patient's ear canal via the body 201 of the soft cap 200, the patient may hear the doctor's instructions that are transmitted to the soft tube 300 via the sound/pressure converter 500 (and via the hard tube 400).

Since, during use, the soft cap 200 of the earphone according to a particular embodiment comes into direct contact with the patient's skin, the issue of sanitation must be considered. For this reason, connecting the earplug 100 to the soft cap 200 detachably is employed in the earphone according to a particular embodiment. The soft cap 200 may be of a disposable material designed for single use, so that the soft cap 200 may be replaced each time the earphone is used. Moreover, the earplug 100 and soft tube 300 may also be of disposable material designed for single use.

The earphone according to a particular embodiment has certain advantages. For one, compared with earphones in the prior art, the earphone according to a particular embodiment offers a stronger noise reduction effect. Additionally, the earphone according to a particular embodiment is of much smaller volume than headphones, and does not need to be secured with the aid of the head; thus the patient is more comfortable, especially when using a head coil at the same time. Further, the earphone according to a particular embodiment may avoid faults or blockage caused by foreign matter entering the earplug, as well as avoiding an inability to block noise as a result of dislocation of the soft cap.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. An earphone, comprising:
an earplug that is a rigid pipe;
a soft cap that is an elastic sheath,
wherein the soft cap comprises a body and a top end, the body being in the form of a hole, the top end covering one end of the body, an inner wall of the body matching an outer wall of the earplug, and one end of the earplug being positioned in the body.

2. The earphone as claimed in claim 1, wherein an outer diameter of the soft cap decreases gradually in a direction from the body to the top end.

3. The earphone as claimed in claim 1, wherein a first sound damping provided by material of the body is greater than a second sound damping provided by material of the top end.

4. The earphone as claimed in claim 1, wherein the top end comprises one or more through-holes that run through both an inner wall of the top end and an outer wall of the top end.

5. The earphone as claimed in claim 1, wherein the earplug comprises a flange located on the outer wall of the earplug.

6. The earphone as claimed in claim 5, wherein a side cross section of the flange is rectangular.

7. The earphone as claimed in claim 5, wherein a side cross section of the flange is in a shape of a triangle.

8. The earphone as claimed in claim 7, wherein the triangle is a right triangle having one acute angle of the right triangle pointing towards the top end and another acute angle of the right triangle pointing towards an outer wall of the body.

9. The earphone as claimed in claim 5, wherein one or more grooves are provided on the inner wall of the body, the one or more grooves matching the flange.

10. The earphone as claimed in claim 9, wherein the soft cap is fixed on the earplug through a cooperation of the one or more grooves and the flange.

11. The earphone as claimed in claim 1, wherein the earplug is detachably connected to the soft cap.

12. The earphone as claimed in claim 1, wherein the soft cap is made of a disposable material.

13. The earphone as claimed in claim 1, wherein the earplug is made of a disposable material.

14. The earphone as claimed in claim 1, wherein the earplug and the soft cap are made of disposable materials.

15. A sound-making device, comprising:
a sound/pressure converter; and
an earphone having:
an earplug that is a rigid pipe;
a soft cap that is an elastic sheath,
wherein the soft cap comprises a body and a top end, the body being in the form of a hole, the top end covering one end of the body, an inner wall of the body matching an outer wall of the earplug, and one end of the earplug being positioned in the body.

16. The sound-making device as claimed in claim 15, further comprising a soft tube having a first end and a second end opposite the first end, wherein the soft tube is connected at the first end to the earplug and the soft tube is connected at the second end to the sound/pressure converter.

17. The sound-making device as claimed in claim 15, further comprising a soft tube and a hard tube, wherein the earplug is connected to the soft tube, the soft tube is connected to the hard tube, and the hard tube is connected to the sound/pressure converter.

18. The sound-making device as claimed in claim 15, wherein an outer diameter of the soft cap decreases gradually in the direction from the body to the top end.

19. The sound-making device as claimed in claim 15, wherein the earplug is detachably connected to the soft cap.
